(19) United States
(12) Patent Application Publication
(10) Pub. No.: US 2021/0027534 A1
(43) Pub. Date: Jan. 28, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Shigenaga FUJIMURA, Kanagawa (JP); Atsushi OGIHARA, Kanagawa (JP)

(73) Assignee: FUJI XEROX CO., LTD., Tokyo (JP)

(21) Appl. No.: 16/745,383

(22) Filed: Jan. 17, 2020

(30) Foreign Application Priority Data
Jul. 24, 2019 (JP) 2019-136281

(51) Int. Cl. G06T 17/20; G06T 19/20

(52) U.S. Cl. CPC G06T 17/20; G06T 2219/2021; G06T 2200/24; G06T 19/20

(57) ABSTRACT

An information processing apparatus includes a receiving unit configured to receive, as a selected voxel, a voxel that is included in a component desired to be selected by a user among components included in a three-dimensional model and that is a voxel positioned on a surface of the three-dimensional model and selected by the user, a generating unit configured to generate, when the generating unit successively refers to positions of voxels on the surface of the three-dimensional model in directions away from the selected voxel, and when a line of voxels in which a predetermined change in a shape of the three-dimensional model first appears in each of the directions is set as a change point of the shape of the three-dimensional model in the direction, a set of voxels including voxels that are positioned between the selected voxel and each of the change points, which appear in the directions, and a presenting unit configured to present the set of voxels as the component that is desired to be selected by the user.

### CROSS-REFERENCE TO RELATED APPLICATIONS

This application is based on and claims priority under 35 USC 119 from Japanese Patent Application No. 2019-136281 filed Jul. 24, 2019.

### BACKGROUND

### (i) Technical Field

The present disclosure relates to an information processing apparatus and a non-transitory computer readable medium.

### (ii) Related Art

There is a case where it is desired to make a modification to a three-dimensional model that is formed by combining voxels by, for example, selecting a component formed on a surface of the three-dimensional model. In the related art, the following methods are examples of a method for allowing a user to select a component formed on a surface of a three-dimensional model.

For example, when a three-dimensional model is displayed on a screen, and a user selects a voxel, the scope of selection is expanded to include voxels that are adjacent to the selected voxel, so that a plurality of voxels are selected at once. The user repeatedly performs this selection operation and as a result, the user ultimately specifies the voxels forming the component.

In another method, a three-dimensional model is displayed two-dimensionally, and a user is allowed to specify voxels forming a component in such a manner as to surround the voxels by means of dragging for rectangular selection or performing rubber band selection, so that the user selects the voxels forming the component in a two-dimensional range.

An example of the related art is disclosed in, for example, Japanese Unexamined Patent Application Publication No. 2002-366934.

In general, when a component is relatively large, the number of times a selection operation is performed is large. In this case, in order to accurately specify the boundary between components, it is necessary to perform adjustment to avoid excess and deficiency by, for example, excluding a surplus of selected voxels from the scope of selection or including missing voxels in the scope of selection. In the case where the whole range of a component is specified by a user in this manner, the user needs to perform a selection operation many times, and it takes time and effort to select the component.

### SUMMARY

Aspects of non-limiting embodiments of the present disclosure relate to enabling a component to be selected more easily than in the case where a user specifies all the voxels included in a component that is desired to be selected.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a receiving unit configured to receive, as a selected voxel, a voxel that is included in a component desired to be selected by a user among components included in a three-dimensional model and that is a voxel positioned on a surface of the three-dimensional model and selected by the user, a generating unit configured to generate, when the generating unit successively refers to positions of voxels on the surface of the three-dimensional model in directions away from the selected voxel, and when a line of voxels in which a predetermined change in a shape of the three-dimensional model first appears in each of the directions is set as a change point of the shape of the three-dimensional model in the direction, a set of voxels including voxels that are positioned between the selected voxel and each of the change points, which appear in the directions, and a presenting unit configured to present the set of voxels as the component that is desired to be selected by the user.

### BRIEF DESCRIPTION OF THE DRAWINGS

Exemplary embodiments of the present disclosure will be described in detail based on the following figures, wherein:

FIG. 1 is a block schematic diagram illustrating an information processing apparatus according to a first exemplary embodiment of the present disclosure;

FIG. 2 is a flowchart illustrating a component extraction process in accordance with the first exemplary embodiment;

FIG. 3 is a schematic diagram illustrating a three-dimensional model displayed on a display in accordance with the first exemplary embodiment and is a diagram illustrating only a portion of the three-dimensional model that corresponds to a component to be selected by a user;

FIG. 4 is a flowchart illustrating set-of-voxels generation processing in accordance with the first exemplary embodiment;

FIG. 5 is a diagram illustrating a layer formed by cutting the three-dimensional model in a Y-Z plane direction in accordance with the first exemplary embodiment;

FIG. 6 is a schematic diagram illustrating the three-dimensional model that is displayed on a screen after a selected component has been extracted in accordance with the first exemplary embodiment and is a diagram illustrating only a portion of the three-dimensional model that corresponds to the selected component; and

FIG. 7 is a flowchart illustrating set-of-voxels generation processing in accordance with a second exemplary embodiment.

### DETAILED DESCRIPTION

Exemplary embodiments of the present disclosure will be described below with reference to the drawings.

### First Exemplary Embodiment

An information processing apparatus according to a first exemplary embodiment that handles a three-dimensional model may be constructed by a general-purpose hardware configuration of the related art such as a personal computer (PC). In other words, the information processing apparatus according to the first exemplary embodiment includes a storage unit such as a CPU, ROM, RAM, or a hard disk drive (HDD), an input unit such as a mouse or a keyboard, and a display unit such as a display. In addition, the information processing apparatus includes a communication unit such as a network interface as necessary.

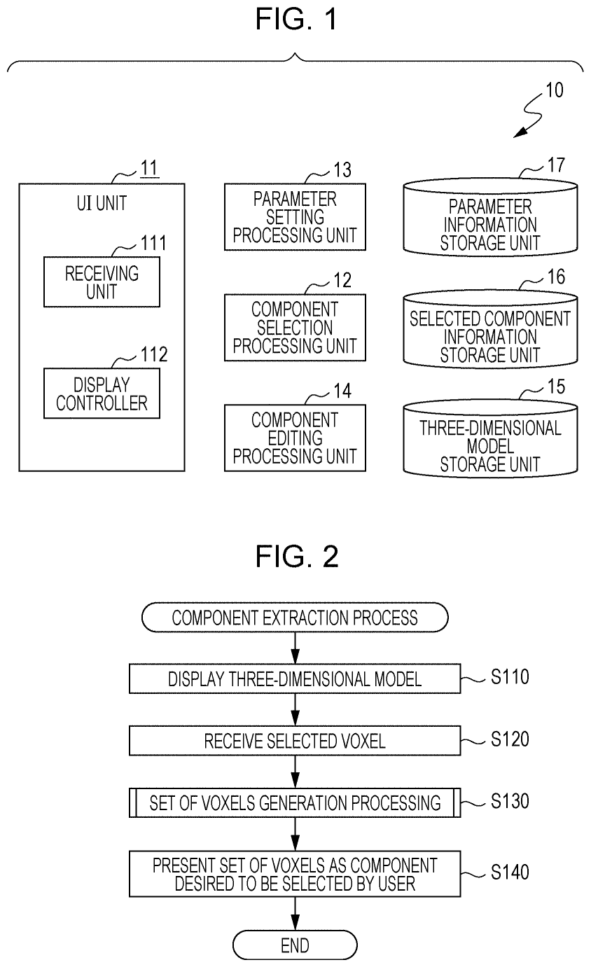

FIG. 1 is a block schematic diagram illustrating an information processing apparatus 10 according to the first exemplary embodiment. The information processing apparatus 10 according to the first exemplary embodiment includes a user interface (UI) unit 11, a component selection processing unit 12, a parameter setting processing unit 13, a component editing processing unit 14, a three-dimensional model storage unit 15, a selected-component information storage unit 16, and a parameter information storage unit 17. Note that components that are not used in the description of the first exemplary embodiment are not illustrated in FIG. 1.

The three-dimensional model storage unit 15 stores a three-dimensional model that is handled in the first exemplary embodiment. The term “three-dimensional model” refers to model data that is used for, for example, causing a 3D printer or the like to form a three-dimensional object. In the first exemplary embodiment, a three-dimensional model is model data used for representing a model by using voxels that are basic elements of a three-dimensional object, and is generated in accordance with, for example, a 3D printing data format called fabricatable voxel (FAV). In the first exemplary embodiment, the term “three-dimensional model” may sometimes refer to data itself and may sometimes refer to an image of the data displayed on a screen.

The selected-component information storage unit 16 stores information that is related to a component selected from a three-dimensional model by a user. Although an internal structure of a three-dimensional model created in accordance with the FAV may be set, the description of the first exemplary embodiment focuses on a component that is formed on a surface of a three-dimensional model unless otherwise stated. In addition, the following description will focus on voxels that forms a surface of a three-dimensional model. Although it will be described in detail later, in the first exemplary embodiment, when a predetermined change appears in the shape of a three-dimensional model, a line of voxels on a surface of the three-dimensional model in which the predetermined change appears is extracted as a boundary between a component that is desired to be selected by a user and a portion that is not desired to be selected by the user, and the parameter information storage unit 17 stores a parameter that is used as a determination criterion to determine whether the predetermined change appears.

The user interface unit 11 includes a receiving unit 111 that receives information input by a user using the input unit and a display controller 112 that performs display control for processing results obtained by the component selection processing unit 12 or the like, that is, for example, a component that is desired to be selected by the user and that has been extracted through a process.

When the receiving unit 111 receives a voxel (hereinafter referred to as a “selected voxel”) on a surface of a three-dimensional model displayed on a screen, the voxel being selected by the user, the component selection processing unit 12 generates a set of voxels by using voxels that are positioned on the surface of the three-dimensional model between the selected voxel and the above-mentioned boundary between a component that is desired to be selected by the user and a portion that is not desired to be selected by the user. The generated set of voxels corresponds to the component that is desired to be selected by the user.

In the following description, a component that is extracted from the surface of the three-dimensional model by the component selection processing unit 12 as a result of the user selecting the selected voxel will hereinafter be referred to as a “selected component”.

The parameter setting processing unit 13 causes the user interface unit 11 to display a predetermined parameter setting screen in accordance with a user operation and provides a parameter setting function that allows the user to change data defining the predetermined change, that is, a set value of the parameter, on the parameter setting screen.

Considering the case where a change in the shape of the three-dimensional model is small or complex, there may be a case where the component that is desired to be selected by the user and the set of voxels extracted by the component selection processing unit 12 (i.e., the selected component) do not match each other. The component editing processing unit 14 causes the user interface unit 11 to display a predetermined editing screen in accordance with a user operation and allows the user to edit the set of voxels generated by the component selection processing unit 12 on this editing screen so as to provide an editing function of making a fine adjustment of the shape of the selected component.

The components 11 to 14 in the information processing apparatus 10 are each implemented by a cooperative operation of a computer forming the information processing apparatus 10 and a program run by the CPU included in the computer. The storage units 15 to 17 are each constructed by an HDD included in the information processing apparatus 10. Alternatively, RAM or an external storage unit may be used via a network.

Programs that are used in the first exemplary embodiment is configured by an application for processing a three-dimensional model and may be provided by being stored in a computer-readable recording medium such as a CD-ROM or a USB memory as well as may be provided by a communication unit. The programs provided by using a communication unit or a recording medium are installed in the computer, and various processing operations are executed as a result of the CPU of the computer successively running the programs.

A component extraction process in the first exemplary embodiment will be described below with reference to the flowchart illustrated in FIG. 2.

The display controller 112 causes the display to display a model selection screen (not illustrated) in accordance with a predetermined operation performed by the user. In the model selection screen, information, such as a name or an image of a three-dimensional model, that is stored in the three-dimensional model storage unit 15 and with which the three-dimensional model may be determined is displayed. When the receiving unit 111 receives a three-dimensional model selected by the user, the display controller 112 displays an image of the selected three-dimensional model on the display (step 110).

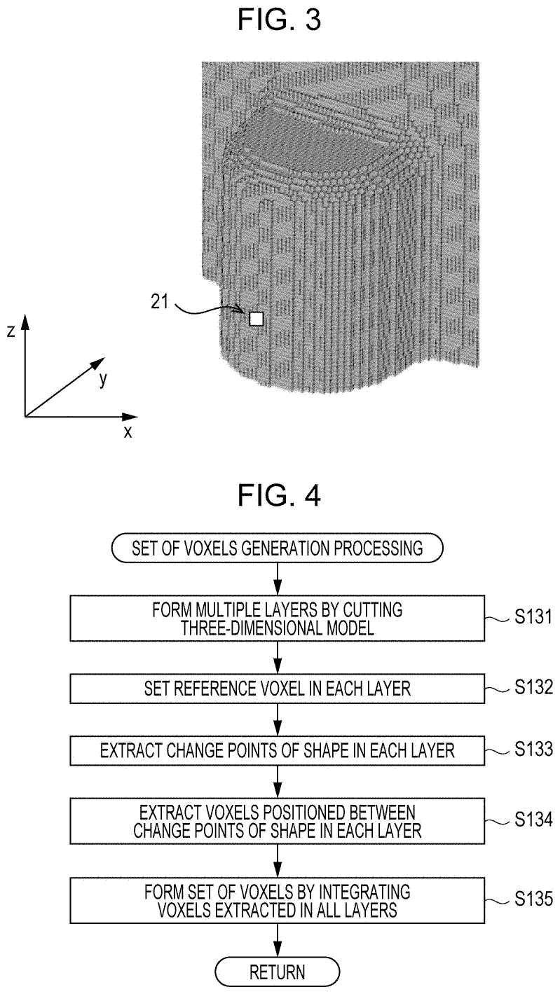

FIG. 3 is a schematic diagram illustrating a three-dimensional model displayed on the display and illustrating only a component to selected by a user and the peripheral portion. FIG. 6 illustrates a selected component 23 extracted through a process, which will be described later, and the boundary 25 between the selected component 23 and another portion 24 is represented by a line. A component is formed on a body or on another component, and in the first exemplary embodiment, a semicylindrical portion projecting from a body of the three-dimensional model will be described as the component that is desired to be selected by the user. Accordingly, in the following description, the portion 24 of the three-dimensional model that is not the selected component 23 will be referred to as the “body”.

The user selects a voxel included in the component that the user desires to select, the voxel being located at an arbitrary position on the three-dimensional model displayed on the display as illustrated in FIG. 3 as an example. When the receiving unit 111 receives the voxel selected by the user (i.e., the selected voxel 21) (step 120), the component selection processing unit 12 generates a set of voxels including the selected voxel 21 by performing processing that will be described below while the position of the selected voxel 21 functions as a reference (step 130). Set-of-voxels generation processing in the first exemplary embodiment will be described below with reference to the flowchart illustrated in FIG. 4.

First, the component selection processing unit 12 forms a plurality of layers each having a thickness equivalent to one voxel by cutting the three-dimensional model in any two-dimensional direction (step 131). Note that although the three-dimensional model may be formed by combining voxels having different sizes, in the first exemplary embodiment, all the voxels have the same shape and the same size for convenience of description.

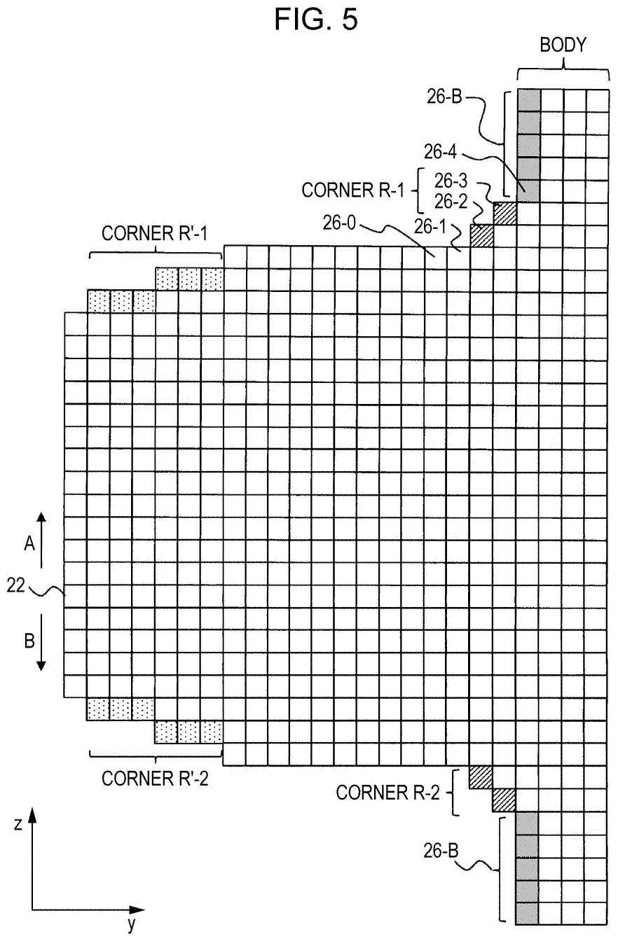

FIG. 5 is a diagram illustrating one of layers formed by cutting the three-dimensional model in a Y-Z plane direction. When the three-dimensional model is cut into the layers, the selected voxel 21 is included in only one of the layers. In other words, the other layers do not include the selected voxel 21, and thus, in these layers, there is no voxel that functions as a reference in the processing that will be described later. Accordingly, the component selection processing unit 12 sets a reference voxel 22 in each of these layers on the basis of the position of the selected voxel 21 (step 132).

In the layer that includes the selected voxel 21, the selected voxel 21 is set as the reference voxel 22. In each of the other layers, which do not include the selected voxel 21, one of the voxels forming the surface of the three-dimensional model, that is, a voxel that is located on the outer periphery of the layer and that is closest to the selected voxel 21 is set as the reference voxel 22 of the layer. Although it may depend on the shape of the three-dimensional model, in the case where the body 24 and the selected component 23 have a positional relationship illustrated in FIG. 3 as an example in which the body 24 and the selected component 23 are aligned in the Y-axis direction, in each of the other layers, a voxel that has the same Z coordinate value as the selected voxel 21 is the voxel that is closest to the selected voxel 21 and is set as the reference voxel 22.

After setting the reference voxel 22 in each of the layers, the component selection processing unit 12 extracts change points of the shape of the surface of the three-dimensional model in the layers (step 133). In order to extract the change points, processing that will be described below is performed on the outer periphery of each of the layers in the direction of arrow A going upward from the reference voxel 22 in FIG. 5 and in the direction of arrow B going downward from the reference voxel 22 in FIG. 5. Note that, in the case where the layers are formed by cutting the three-dimensional model in the Y-Z plane direction as in the above case, all the voxels on the outer periphery of each of the layers have the same X coordinate value. The directions of arrows A and B are directions along the Y-axis and the Z-axis.

First, the component selection processing unit 12 successively refers to the positions of voxels that are arranged in the direction of arrow A, which is a direction away from the reference voxel 22. Then, the component selection processing unit 12 extracts a line of voxels with which a predetermined change first appears in the shape of the outer periphery as a change point of the shape of the three-dimensional model (hereinafter also simply referred to as a “change point”). Although details of the predetermined change will be described later, since the selected component 23 projects from the body 24, the Z coordinate values indicating the positions of voxels that are located at projecting positions vary relatively greatly. In this manner, the component selection processing unit 12 extracts a line of the voxels in which a large change appears as a change point.

Note that a change does not appear in the shape with a single voxel, and a change point of the shape is extracted with a plurality of continuous voxels. In the first exemplary embodiment, a “corner R-1” illustrated in FIG. 5 is a position where a change that corresponds to the predetermined change first appears. The phrase “first appears” is used because there is a possibility that a change that corresponds to the predetermined change will also appear on the body 24 ahead of the “corner R-1” on the outer periphery of the layer, and this refers to extracting only a position that is closest to the reference voxel 22 and at which a change corresponding to the predetermined change appears as a change point.

Similar to the above process, the component selection processing unit 12 successively refers to the positions of voxels that are arranged in the direction of arrow B, which is another direction away from the reference voxel 22. Then, the component selection processing unit 12 extracts a line of voxels with which the predetermined change first appears in the shape of the outer periphery, that is, a “corner R-2” in FIG. 5, as a change point of the shape of the three-dimensional model. Note that, in FIG. 5, the lower portion may be processed before the upper portion is processed.

After extracting a change point in the direction of arrow A, which is a direction away from the reference voxel 22, and a change point in the direction of arrow B, which is another direction away from the reference voxel 22, in each of the layers, the component selection processing unit 12 extracts voxels that are positioned between the reference voxel 22 and each of the extracted change points in each of the layers, that is, voxels positioned in a region that extends from the “corner R-1” to the “corner R-2” passing through the reference voxel 22 (step 134).

In the case of the shape of the selected component 23 that is illustrated in FIG. 6 as an example, when the process of extracting change points is executed on each of the layers formed by cutting the three-dimensional model in the Y-Z plane direction, although change points along the X-axis (i.e., the “corner R-1” and the “corner R-2” in FIG. 5) may be extracted, it is difficult to correctly extract change points along the Z-axis. Note that, when it is not necessary to distinguish the “corner R-1” and the “corner R-2”, they will be collectively called “corners R”. Similarly, a “corner R′-1” and a “corner R′-2” will be collectively called “corners R′”.

In this case, the component selection processing unit 12 extracts change points from layers that are formed by cutting the three-dimensional model in another two-dimensional direction and performs the processing operations for extracting voxels (steps 133 and 134). Then, the component selection processing unit 12 performs processing for integrating the processing results obtained from the layers formed by cutting the three-dimensional model in both the two-dimensional directions. In the case of the selected component 23 that is illustrated in FIG. 6 as an example, it is desirable to form layers by cutting three-dimensional model in an X-Y plane direction. In addition, similar processing may also be performed on the layers formed by cutting the three-dimensional model in the X-Z plane direction. As described above, although it may depend on the shape of a component and the positional relationship between a body and a component, layers may be formed by cutting a three-dimensional model in two or three directions (i.e., all directions) without limiting the cutting direction to a single two-dimensional direction, and change points may be extracted by combining the processing results obtained by cutting the three-dimensional model in the two-dimensional directions.

After extracting voxels from each of the layers in the manner described above, the component selection processing unit 12 generates a set of voxels by integrating the voxels extracted from the layers (step 135). There is a possibility that appropriate voxels may not be extracted from the layers depending on the shape of the three-dimensional model or a two-dimensional direction in which the three-dimensional model is cut, and thus, the component selection processing unit 12 may refer to voxel extraction results obtained from each layer and may perform adjustment for selecting voxels by, for example, including a voxel obtained from two or more of the layers in the set of voxels.

Note that, in the first exemplary embodiment, after change points positioned on opposite sides of the reference voxel 22 have been extracted from each of the layers, voxels that are positioned between the change points are extracted (steps 133 and 134), and a set of voxels is generated by integrating the extracted voxels. However, after change points have been extracted by cutting the three-dimensional model in one or a plurality of two-dimensional directions (step 133), the boundary 25 between the body 24 and the selected component 23 may be formed first by connecting the change points of the shape, which have been extracted from the layers, to one another (i.e., the cut layers are brought back together into the original three-dimensional model), and a set of voxels may be generated by using voxels that are positioned between each of the selected voxels 21 and the boundary 25 positioned in the vicinity of the selected voxels 21. Note that the boundary 25 is formed by connecting voxels that are included in the lines of voxels forming their respective change points and that are farthest from their respective selected voxels 21.

Note that, although the boundary 25 is included in the selected component 23 in the first exemplary embodiment, the boundary 25 is not necessarily included in the selected component 23. In the case where the boundary 25 is not included in the selected component 23, voxels each of which is adjacent to, on the side on which the selected voxel 21 is present, a corresponding one of the lines of voxels forming the change points are the voxels that form the boundary 25. Whether to include the boundary 25 in the selected component 23 may be automatically decided by the component selection processing unit 12 or may be selected by the user.

Returning to FIG. 2, after the set of voxels has been generated in the manner described above, the component selection processing unit 12 registers selected-component information that includes information with which the voxels forming the set of voxels (i.e., the selected component 23) are determined into the selected-component information storage unit 16. Then, the display controller 112 causes the set of voxels to be displayed as the selected component 23 on the display in accordance with an instruction from the component selection processing unit 12 so as to present it to the user (step 140). For convenience of description, although FIG. 6 illustrates the selected component 23 with the boundary 25 represented by a line, the boundary 25 does not need to be explicitly represented by a line. In this case, different display forms, such as different display colors, are used for the selected component 23 and the body 24 so as to clearly illustrate the position and the area of the selected component 23.

The predetermined change that appears in the shape of the three-dimensional model, that is, a parameter that is stored in the parameter information storage unit 17, will now be described.

As described above, the component selection processing unit 12 refers to the positions of voxels that are arranged on the outer periphery of each of the layers in a direction away from the reference voxel 22 and extracts a line of voxels with which the predetermined change first appears in the outer periphery, that is, the shape of the three-dimensional model, as a change point of the shape of the three-dimensional model. A component formed on the surface of the three-dimensional model is a portion that projects from the surface of the three-dimensional model or that is recessed in the surface of the three-dimensional model and is assumed to be a portion in which there are large variations in the positions of the voxels on the surface of the three-dimensional model. Thus, the component selection processing unit 12 determines that the predetermined change appears when a large change appeared in the positional relationship between one of the voxels on the outer periphery of the layer (e.g., a “first voxel”) and another one of the voxels on the outer periphery of the layer (e.g., a “second voxel”) that is adjacent to the first voxel, specifically, when the distance between the center of the first voxel and the center of the second voxel or the distance between a predetermined corner of the first voxel and a predetermined corner of the second voxel becomes equal to or greater than a predetermined threshold. This threshold corresponds to a set value of the above-mentioned parameter and is data that defines the predetermined change. Note that, here, it is assumed that the predetermined change is a large change. However, for example, if a voxel on a curved surface of the three-dimensional model is selected as a selected voxel, the component selection processing unit 12 may determine that the predetermined change appears when the distance between the center of the first voxel and the center of the second voxel, which has been equal to or greater than the predetermined threshold value, falls below the threshold, that is, the component selection processing unit 12 may determine that the predetermined change appears when the shape of the three-dimensional model becomes closer to a flat surface from the curved surface. In addition, in this case, although the positional relationship between two voxels, which are the first voxel and the second voxel, has been described as an example, the number of voxels forming a line of voxels and so forth are also set as parameters. In the case where a line of voxels is set to include three or more voxels, the threshold may be set for each pair of the voxels. In addition, in the case where layers are formed by cutting the three-dimensional model in a plurality of two-dimensional directions, a parameter that is set for detecting the predetermined change may be set for each cutting direction.

The predetermined change will be specifically described with reference to FIG. 5. In the layer that is illustrated in FIG. 5, although the “corner R-1” and the “corner R-2” are extracted as change points, the same determination criterion is used for extracting each of the “corner R-1” and the “corner R-2” as the predetermined change, and thus, the “corner R-1” will be described below as an example. Strictly speaking, it is necessary to replace the word “higher” with “lower” in the following description.

The component selection processing unit 12 refers to the positions of the voxels, which are located on the outer periphery, in the direction of arrow A from the reference voxel 22. Here, for example, it is assumed that a determination criterion is set such that one of two adjacent voxels is positioned in a row directly above the row in which the other of the two adjacent voxels is positioned in the Z-axis direction (i.e., the one of the two adjacent voxels is positioned higher than the other of the two adjacent voxels by the height of one voxel in the Z-axis direction), and three or more continuous voxels have this positional relationship. In this case, there is no line of voxels that satisfies the above determination criterion among the voxels that are located between the reference voxel 22 and a voxel 26-1. A voxel 26-2 that is adjacent to the voxel 26-1 is positioned in a row directly above the row in which the voxel 26-1 is positioned. In addition, a voxel 26-3 that is adjacent to the voxel 26-2 is positioned in a row directly above the row in which the voxel 26-2 is positioned. Furthermore, a voxel 26-4 that is adjacent to the voxel 26-3 is positioned in a row directly above the row in which the voxel 26-3 is positioned. Therefore, this line of voxels satisfies the determination criterion. Accordingly, the voxels 26-2 and 26-3 among the voxels 26-1 to 26-4 other than the voxels that are positioned at the opposite ends are extracted as a change point. Note that only the voxel 26-4 that satisfies the determination criterion and whose position is referred to last by the component selection processing unit 12 may be excluded. In addition, the voxel 26-1 does not satisfy the determination criterion with respect to a voxel 26-0 whose position is referred to immediately before the position of the voxel 26-1 is referred to by the component selection processing unit 12, and thus, the voxel 26-1 may be set beforehand not to be included in the line of voxels forming the change point.

In the manner described above, the voxels 26-2 and 26-3 are extracted as the voxels forming the “corner R-1”. Note that the voxel 26-1 that is adjacent to the “corner R-1” is included in the selected component 23, and the voxel 26-4 is one of voxels 26-B that form the body 24. In FIG. 5, the voxels forming the “corner R-1” are illustrated by hatching, and the voxels 26-B forming the body 24 are illustrated in gray. In addition, although the “corners R′” are indicated by a dot pattern in FIG. 5, the “corners R′” do not correspond to the predetermined change because they do not satisfy the above determination criterion.

Note that, although a condition under which it is determined that the predetermined change appears is set as the above determination criterion, a condition under which it is not determined that the predetermined change appears, that is, an exceptional line of voxels with which it is not determined that the predetermined change appears even if the line of voxels satisfies the determination criterion, may be defined.

Although a case has been described in which a set of voxels that are generated by the component selection processing unit 12, that is, the selected component 23, matches a component that a user desires to select, a case may be assumed in which a problem in that the selected component 23 does not actually match a component that a user desires to select occurs. For example, in the case of the shape of the component that is illustrated in FIG. 3 and FIG. 5 as an example, it is desirable that each of the “corners R” be extracted as a change point that first appears while each of the “corners R′” is not extracted as a change point. However, the “corners R′” may be extracted as change points depending on the parameter setting. In addition, there is a possibility that the “corners R”, which are desired to be extracted, will not be extracted as change points. Accordingly, the first exemplary embodiment provides a function of changing the parameter setting.

If a processing result that a user desires is not obtained, that is, in the case where the component that is desired to be selected by the user and the selected component 23 do not match each other, the user invokes the parameter setting function by operating a menu bar or a toolbar on a main screen provided by an application that is capable of handling a three-dimensional model. The parameter setting processing unit 13 is activated in response to this user operation and then instructs the display controller 112 to display a parameter setting screen (not illustrated) for changing data defining the predetermined change that is, a parameter. Subsequently, the user changes the set value of the parameter, and then, the component selection processing unit 12 executes the above-mentioned component extraction process again by using the parameter whose set value has been changed. In this manner, the user is allowed to change the parameter setting, so that the processing result that is illustrated in FIG. 6 as an example is obtained.

Alternatively, the user may be allowed to specify a plurality of selected voxels 21. In this case, the receiving unit 111 receives the plurality of selected voxels, and the component selection processing unit 12 executes the above-mentioned component extraction process for each of the specified selected voxels 21. Then, a set of voxels is obtained by integrating the execution results. Note that the user may collectively specify the plurality of selected voxels 21 or may specify the selected voxels 21 to be added by referencing to processing results obtained by the component selection processing unit 12.

In the case where the user specifies a plurality of selected voxels, a parameter may be set for each selected voxel. For example, in a three-dimensional model, the parameter value set for a selected voxel on a flat surface may be different from the parameter value set for a selected voxel on a curved surface.

In order to address a problem with a set of voxels generated by the component selection processing unit 12, the configuration of the set of voxels may be edited in addition to changing the parameter setting. The user invokes a component editing function by operating the menu bar or the toolbar on the main screen provided by the above-mentioned application. The component editing processing unit 14 is activated in response to this user operation and then instructs the display controller 112 to display an editing screen for editing the set of voxels generated by the component selection processing unit 12. A three-dimensional model, which is a processing target, is displayed in the editing screen, and each of the voxels forming the three-dimensional model is selectable. In other words, when the user chooses to add a voxel to the set of voxels and selects the voxel, the component editing processing unit 14 includes the voxel selected by the user in the set of voxels in response to the user operation. Conversely, when the user chooses to remove a voxel from the set of voxels and selects the voxel, the component editing processing unit 14 removes the voxel selected by the user from the existing set of voxels in response to the user operation.

In the first exemplary embodiment, since the processing is performed while focusing on the surface of a three-dimensional model, a set of voxels that corresponds to a selected component is formed of only the voxels forming the surface of the three-dimensional model, that is, technically, only the surface profile of the three-dimensional model is extracted as the selected component 23. A three-dimensional model that is handled in the first exemplary embodiment has also an internal structure. Accordingly, a set of voxels generated by the component selection processing unit 12 is the surface of a component that is desired to be selected by a user, and an internal structure that is formed of voxels that are located in a space enclosed by the surface may also be included in the component that is desired to be selected by the user.

In the first exemplary embodiment, for convenience of description, all the voxels have the same size, and a plurality of layers each having a thickness equivalent to one voxel are formed. However, there are not a few components having a boundary that extends linearly like the boundary 25 illustrated in FIG. 6 as an example. In this case, it is attempted to form a layer having a thickness equivalent to a plurality of voxels. if a plurality of voxels corresponding to the thickness of a layer are connected to each other so as to form one virtual voxel, a layer having a thickness equivalent to one virtual voxel may be formed. The above-mentioned set-of-voxels generation processing may be performed on such a layer formed in this manner described above. However, in a layer that corresponds to a portion where the boundary 25 does not extend linearly such as an end portion of the selected component 23, there is a possibility that change points may not be extracted accurately. Regarding an unprocessable layer such as a layer in which change points have not been extracted accurately or in which there is a possibility that change points may not be extracted accurately, the one virtual voxel may be disintegrated into a plurality of voxels so as to split the layer into the original layers each having a thickness equivalent to one voxel, and then the above-mentioned set-of-voxels generation processing may be performed again. Note that such an unprocessable layer may be determined by referencing to execution results obtained by the component selection processing unit 12, and for example, when the shapes of adjacent layers among the layers formed by cutting a three-dimensional model are the same as or similar to each other, the adjacent layers may be connected to each other.

### Second Exemplary Embodiment

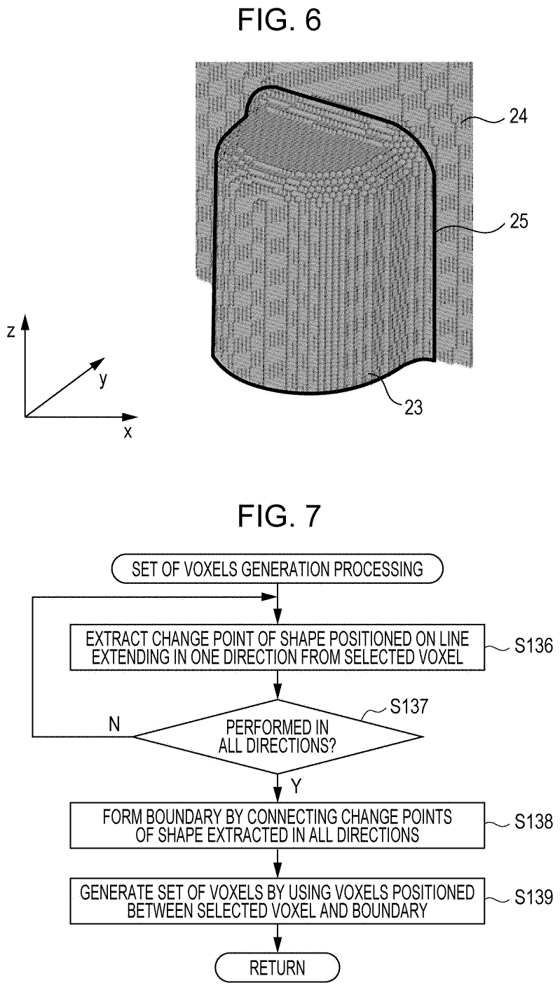

In the above-described first exemplary embodiment, the selected component 23 is extracted through the process of forming layers by cutting a three-dimensional model in a two-dimensional direction. In a second exemplary embodiment, the selected component 23 is extracted through a process different from that in the first exemplary embodiment. The set-of-voxels generation processing in the second exemplary embodiment will be described below with reference to the flowchart illustrated in FIG. 7. Note that, in the second exemplary embodiment, the hardware configuration and the functional block configuration of the information processing apparatus 10 and the steps other than the set-of-voxels generation processing in the component extraction process may be the same as those in the first exemplary embodiment, and thus, the descriptions thereof will be omitted.

First, the component selection processing unit 12 successively refers to the positions of voxels arranged on a line extending in one direction away from the selected voxel 21 that is received by the receiving unit 111. The second exemplary embodiment also focuses on only voxels that form the surface of a three-dimensional model. The component selection processing unit 12 performs extraction processing for extracting, as a change point of the shape of the three-dimensional model, a line of voxels with which the predetermined change first appears on the line extending in the one direction (step 136). The processing for extracting a change point on a line extending in one direction is repeated until this processing is performed in all the directions away from the whole periphery of the selected voxel 21, that is, in all the directions through 360 degrees (N in step 137). After the extraction processing has been performed in all the directions (Y in step 137), the component selection processing unit 12 connects change points that are extracted by performing the extraction processing on the lines extending in all the directions away from the selected voxel 21 so as to form the boundary 25 between the selected component 23 and the body 24 (step 138). Then, the component selection processing unit 12 generates a set of voxels by using the voxels that are located between the selected voxel 21 and the boundary 25 (step 139).

Although only one selected voxel 21 may be selected in the second exemplary embodiment, also in the case where a plurality of selected voxels 21 are selected, a set of voxels that corresponds to the selected component 23 may be formed by, for example, integrating sets of voxels obtained by using the selected voxels 21 as in the first exemplary embodiment.

### Third Exemplary Embodiment

Although a three-dimensional model that is handled in the above-described exemplary embodiments has a structure formed of voxels, in the case where a three-dimensional model is generated by converting three-dimensional model data that does not use voxels, a set of voxels may be generated by referencing to the three-dimensional model data before conversion. This is because a three-dimensional model having a voxel structure has a structure in which voxels each having a three-dimensional shape are arranged, and thus, it is relatively difficult to determine a portion where a change occurs in the shape and the degree of the change.

For example, stereolithography (STL) data is three-dimensional model data that is used for representing a three-dimensional solid shape by an aggregate of small triangles (generally called “polygons”), and in the case where a three-dimensional model in the third exemplary embodiment is generated by converting STL data, reference is made to the STL data. In a three-dimensional model having a polygon mesh structure, it is easier to determine a portion where a change occurs in the shape and the degree of the change by referencing to the shapes of polygons and the positional relationships among the polygons compared with the case of a three-dimensional model having a voxel structure.

More specifically, the component selection processing unit 12 extracts the boundary between a selected component and a body from changes in the sizes of polygons, the lengths of the sides of the polygons, the angle formed by adjacent polygons, and so forth that are set in STL data, and generates a set of voxels that forms the selected component 23 by determining voxels that correspond to the boundary in the three-dimensional model generated by converting the STL data.

Creating a 3D shape by using a 3D CAD system is called “modeling”, and one of the modeling systems is history-based CAD. The history-based CAD is a CAD system that records a history of operations for creating a shape and combines unit shapes so as to create the shape of a target three-dimensional model. The unit shapes to be combined are called “features”, and three-dimensional model data used in this modeling system includes history information related to a history of processing operations such as combining features. Such a processing history itself may sometimes be called “features”. For example, the component selection processing unit 12 determines that a feature that corresponds to the selected voxel 21 is a feature of a cylindrical shape added to a body of a three-dimensional model by analyzing history information included in three-dimensional model data that has not yet been converted. Then, the component selection processing unit 12 uses history information indicating that the feature of the cylindrical shape is added to the body, a feature of the shapes of the corners R′ is added to the cylindrical shape, and a feature of the shapes of the corners R is further added to the cylindrical shape and extracts voxels corresponding to the features of the cylindrical shape, the corners R′, and the corners R in the three-dimensional model having a voxel structure and generated by converting the three-dimensional model data, so as to generate a set of voxels.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit configured to receive, as a selected voxel, a voxel that is included in a component desired to be selected by a user among components included in a three-dimensional model and that is a voxel positioned on a surface of the three-dimensional model and selected by the user;
a generating unit configured to generate, when the generating unit successively refers to positions of voxels on the surface of the three-dimensional model in directions away from the selected voxel, and when a line of voxels in which a predetermined change in a shape of the three-dimensional model first appears in each of the directions is set as a change point of the shape of the three-dimensional model in the direction, a set of voxels including voxels that are positioned between the selected voxel and each of the change points, which appear in the directions; and
a presenting unit configured to present the set of voxels as the component that is desired to be selected by the user.

2. The information processing apparatus according to claim 1,
wherein the generating unit generates a plurality of layers by cutting the three-dimensional model in any one two-dimensional direction, the plurality of layers each having a thickness equivalent to one voxel,
wherein, when the selected voxel or a voxel positioned on an outer periphery of each of the layers that do not include the selected voxel, the voxel being closest to the selected voxel, is set as a reference voxel in the layer, the generating unit successively refers to positions of voxels that are arranged on the outer periphery of the layer in two directions away from the reference voxel and then extracts, in each of the directions, a line of voxels in which the predetermined change in a shape of the outer periphery first appears as a change point of the shape of the three-dimensional model,
wherein the generating unit extracts voxels that are positioned between the reference voxel and each of the change points on the outer periphery in each of the layers, the change points being extracted in the two directions, and
wherein the generating unit generates the set of voxels by integrating the voxels extracted in the layers.

3. The information processing apparatus according to claim 1,
wherein the generating unit performs, on lines extending in all directions away from the selected voxel, extraction processing for successively referring to positions of voxels that are arranged on a line extending on the surface of the three-dimensional model in one direction away from the selected voxel and then extracting, as a change point of the shape of the three-dimensional model in the one direction, a line of voxels in which the predetermined change in the shape of the three-dimensional model first appears,
wherein the generating unit forms a boundary between a component that is desired to be extracted by the user and another component by connecting the change points, which are extracted by performing the extraction processing on the lines extending in all the directions away from the selected voxel, and
wherein the generating unit generates a set of voxels including voxels that are positioned between the selected voxel and the boundary.

4. The information processing apparatus according to claim 1,
wherein, when the receiving unit receives a plurality of selected voxels, the generating unit generates the set of voxels by integrating sets of voxels each of which is generated for one of the selected voxels.

5. The information processing apparatus according to claim 4,
wherein the information processing apparatus is capable of setting, for each of the selected voxels, a determination criterion for determining that the predetermined change in the shape of the three-dimensional model appears.

6. The information processing apparatus according to claim 1,
wherein, when the three-dimensional model is generated by converting three-dimensional model data that does not use voxels, the generating unit generates the set of voxels by referencing to the three-dimensional model data.

7. The information processing apparatus according to claim 6,
wherein the three-dimensional model data is three-dimensional model data that is represented by an aggregate of polygons.

8. The information processing apparatus according to claim 6,
wherein the three-dimensional model data is three-dimensional model data including information regarding a feature.

9. The information processing apparatus according to claim 1,
wherein the generating unit is capable of selecting whether to include a line of voxels forming a change point of the shape of the three-dimensional model in the set of voxels.

10. The information processing apparatus according to claim 1,
wherein the component that is desired to be selected by the user is a component that has a surface formed of the set of voxels and an internal structure formed of voxels that are located in a space enclosed by the surface.

11. The information processing apparatus according to claim 1, further comprising:
a user interface unit that is used for changing data that defines the predetermined change.

12. The information processing apparatus according to claim 1, further comprising:
a user interface unit that is used for editing the set of voxels generated by the generating unit.

13. A non-transitory computer readable medium storing a program causing a computer to execute a process, the process comprising:
receiving, as a selected voxel, a voxel that is included in a component desired to be selected by a user among components included in a three-dimensional model and that is a voxel positioned on a surface of the three-dimensional model and selected by the user;
generating, when the generating unit successively refers to positions of voxels on the surface of the three-dimensional model in directions away from the selected voxel, and when a line of voxels in which a predetermined change in a shape of the three-dimensional model first appears in each of the directions is set as a change point of the shape of the three-dimensional model in the direction, a set of voxels including voxels that are positioned between the selected voxel and each of the change points, which appear in the directions; and
presenting the set of voxels as the component that is desired to be selected by the user.

14. An information processing apparatus comprising:
receiving means for receiving, as a selected voxel, a voxel that is included in a component desired to be selected by a user among components included in a three-dimensional model and that is a voxel positioned on a surface of the three-dimensional model and selected by the user;
generating means for generating, when the generating unit successively refers to positions of voxels on the surface of the three-dimensional model in directions away from the selected voxel, and when a line of voxels in which a predetermined change in a shape of the three-dimensional model first appears in each of the directions is set as a change point of the shape of the three-dimensional model in the direction, a set of voxels including voxels that are positioned between the selected voxel and each of the change points, which appear in the directions; and
presenting means for presenting the set of voxels as the component that is desired to be selected by the user.
